(19) United States
(12) Patent Application Publication
(10) Pub. No.: US 2008/0122777 A1
(43) Pub. Date: May 29, 2008

(54) SOURCE DRIVING DEVICE

(75) Inventors: Yao-Hung Kuo, Hsinchu City (TW); Kuang-Feng Sung, Taichung County (TW)

Correspondence Address: J C PATENTS, INC., 4 VENTURE, SUITE 250, IRVINE, CA, 92618, US

(73) Assignee: NOVATEK MICROELECTRONICS CORP., Hsinchu (TW)

(21) Appl. No.: 11/626,536

(22) Filed: Jan. 24, 2007

(30) Foreign Application Priority Data
Nov. 24, 2006 (TW) 95143496

(51) Int. Cl. G09G 3/36

(52) U.S. Cl. 345/98

(57) ABSTRACT

A source driving device, adapted for pixel array of LCDs is provided. The source driving device includes a data latch unit and a plurality of staged converting output units. The data latch unit is adapted for outputting a plurality of digital latch data according to the latch result. Each staged converting output unit utilizes a precharging voltage generated during a first period, and a driving voltage generated during a second period to charge/discharge the pixel array. In such a way, the static power consumption of the operational amplifying circuits is reduced and the speed of the charging/discharging operation to the pixel array is increased.

### CROSS-REFERENCE TO RELATED APPLICATION

This application claims the priority benefit of Taiwan application serial no. 95143496, filed Nov. 24, 2006. All disclosure of the Taiwan application is incorporated herein by reference.

### BACKGROUND OF THE INVENTION

1. Field of the Invention

The present invention generally relates to a source driving device, and more particularly, to a source driving device that utilizes pre-charging voltage and driving voltage to charge/discharge a display panel thereof in stages.

2. Description of Related Art

A source driving device is a key element for a thin film transistor liquid crystal display (TFT LCD). The source driving device converts digital latch data required for image displaying into analog voltage, and outputs to a pixel array of the TFT LCD, on which images corresponding to the digital latch data are displayed.

FIG. 1 is a schematic structural diagram showing a conventional source driving device. For the sake of illustration, FIG. 1 shows a pixel array 120. FIG. 2 is a periodic sequence diagram of the conventional source driving device. Referring to FIGS. 1 and 2, a conventional source driving device 110 includes a reference voltage generator 101, a data latch unit 102, digital-to-analog converting circuits 131-134, operational amplifying circuits 141-144, and switches SW11-SW16.

Referring FIGS. 1 and 2 again, the reference voltage generator 101 is adapted for generating a plurality of grey level voltages. The data latch unit 102 is adapted to generate digital latch data DL11-DL14 according to a latch signal LD in a first period T1. Each of the digital-to-analog converting circuits 131-134 selects one from those grey level voltages for outputting, according to the digital latch data DL11-DL14. The operational amplifying circuits 141-144 improve driving ability of the output signals from the digital-to-analog converting circuits 131-134, so as to generate analog voltages VD11-VD14. The switches SW15 and SW16 are controlled by a control signal CS11 in a second period T2, when the analog voltages VD11-VD14 are being transferred to the pixel array 120.

Meanwhile, charges on two adjacent channels are redistributed so that pixel voltage levels thereof are raised or lowered respectively to a median voltage level. For example, a level of a pixel voltage VP11 declines in the second period T2 to a level of a median voltage VM11, and a level of a pixel voltage VP12 rises in the second period T2 to a level of a median voltage VM12. Next, the switches SW11-SW14 turn on in a third period T3 according to control signal CS12 such that the levels of the pixel voltages raised/lowered to a level of an analog voltage. For example, in the third period T3, the level of the pixel voltage VP11 declines to the level of the analog voltage VD11, and the level of the pixel voltage VP12 rises to the level of the analog voltage VD12.

However, even the conventional source driving device 110 intends to reduce power consumption by redistributing charges thereby, when the levels of the pixel voltage rise, or decline to the level of the reference voltage, the output current of the operational amplifying circuits must increase so as to have enough time to adjust the voltage levels. In other words, for the purpose of obtaining a fast charging/discharging ability, the conventional source driving device 110 must sacrifice certain power consumption of the operational amplifying circuits. Further, as large sized panels becoming popularized, the method of the conventional source driving device 110 can not efficiently improve the charging/discharging ability thereof. Therefore, it is critical that the source driving device, in the art of TFT LCD, to obtain faster charging/discharging ability, without consuming more power of the operational amplifying circuits.

### SUMMARY OF THE INVENTION

Accordingly, the present invention is directed to a source driving device including a staged converting output unit for charging/discharging the pixel array in stages, wherein the source driving device has fast charging/discharging capability and consume comparatively less power of the operational amplifying circuits.

The present invention provides a source driving device for a pixel array of a liquid crystal display (LCD). The source driving device includes a data latch unit and a plurality of staged converting output units. The data latch unit is configured for outputting a plurality of digital latch data according to a latch result. Each staged converting output unit is adapted for generating a precharging voltage in a first period by converting a digital precharging data, and generating a driving voltage in a second period by converting a digital latch data. As such, each staged converting output unit is capable of charging/discharging the pixel array in stages with the precharging voltage and the driving voltage. The digital latch data has a resolution of (M+L) bits, and the digital precharging data has a resolution of M bits, M and L being integers greater than 0.

According to an embodiment of the invention, the (M+L) bits of the foregoing digital latch data are from b[1] to b[M+L], in which b[1] is the most significant bit of the digital latch data, and b[M+L] is the least significant bit of the digital latch data, then the M bits of the digital precharging data are from b[1] to b[M].

According to an embodiment of the present invention, the source driving device further includes a plurality of switches. The switches turn on during a third period, wherein charges of two adjacent channels are redistributed according to the conduction of the switches. Thus, power consumption of the source driving device may be effectively reduced.

According to an embodiment of the present invention, each of the foregoing staged converting output unit includes a coarse adjustment digital-to-analog converter and a fine adjustment digital-to-analog converter. The coarse adjustment digital-to-analog converter is adapted for generating a precharging voltage according to digital precharging data in the first period, while the fine adjustment digital-to-analog converter is adapted for generating a driving voltage according to the digital latch data in the second period.

According to an embodiment of the present invention, the foregoing coarse adjustment digital-to-analog converter includes a third digital-to-analog converting circuit, a second buffer circuit, and a first switch. The third digital-to-analog converting circuit is adapted for selecting one from 2̂M pre-adjusted voltages to output according to the digital precharging data. The second buffer circuit is adapted for improving the driving capability of the output signals of the third digital-to-analog converting circuit, so as to generate precharging voltages. The first switch is turned on during the first period.

According to an embodiment of the present invention, the foregoing fine adjustment digital-to-analog converter further includes a fourth digital-to-analog converting circuit, an operational amplifying circuit, and a second switch. The fourth digital-to-analog converting circuit is adapted for selecting one from 2̂(M+L) grey level voltages to output according to the digital latch data. The operational amplifying circuit is adapted for improving the driving capability of the output signals of the fourth digital-to-analog converting circuit, so as to generate driving voltages. The second switch is turned on during the second period.

The present invention charges/discharges a pixel array in stages with a precharging voltage generated by a staged converting output unit during a first period and a driving voltage generated by the staged converting output unit during a second period. In such a way, the power consumption of the operational amplifying circuits may be effectively reduced, and speed of the source driving device in charging/discharging the pixel array may be effectively increased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram illustrating a conventional source driving device.

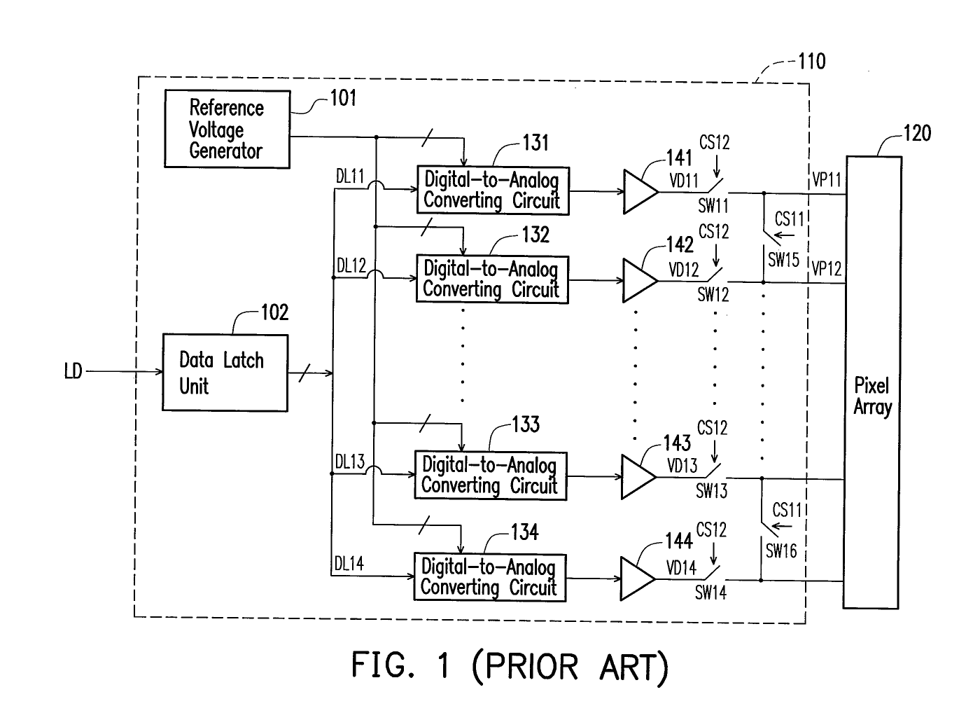

FIG. 2 is a time sequence diagram of the conventional source driving device.

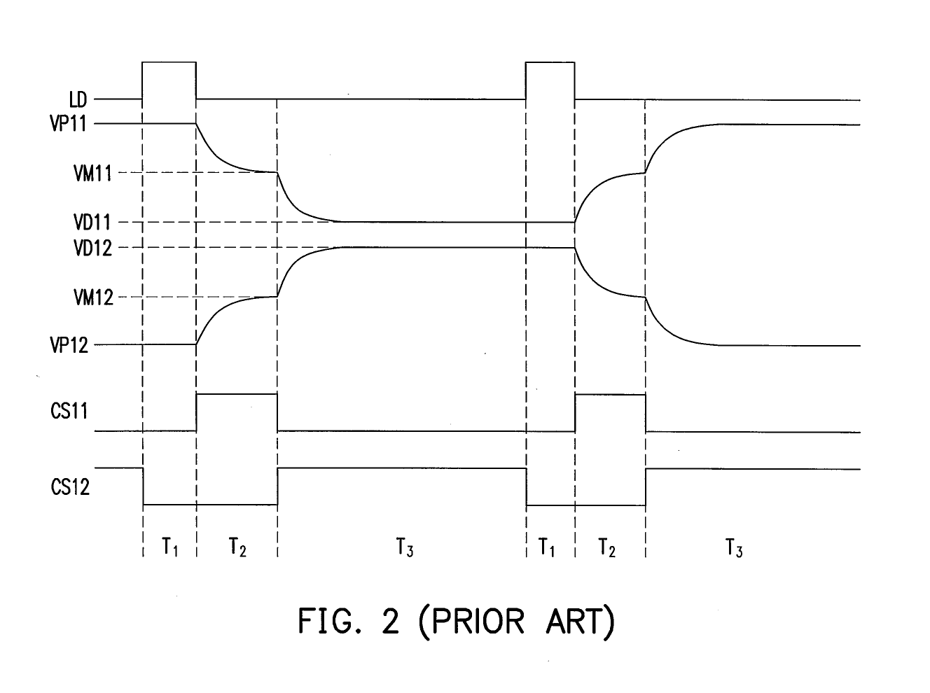

FIG. 3 is a schematic structural diagram illustrating a source driving device according to a preferred embodiment of the present invention.

FIG. 4 is a time sequence diagram of the source driving device according to the preferred embodiment of the present invention.

FIG. 5 is a structural diagram of a staged converting output unit according to an embodiment of the present invention.

FIG. 6 is a time sequence diagram of the staged converting output unit according to the preferred embodiment of the present invention.

FIG. 7 is a structural diagram of a buffer circuit according to an embodiment of the present invention.

FIG. 8 is a time sequence diagram of the buffer circuit according to the embodiment of the present invention.

FIG. 9 is a structural diagram of another buffer circuit according to an embodiment of the present invention.

FIG. 10 is a structural diagram of a source follower according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The main feature of the present invention includes charging/discharging the pixel array in stages with the precharging voltage and the driving voltage generated by staged converting output units so that the source driving device is capable of charging/discharging rapidly even when the power consumption of the operational amplifying circuits is reduced. The source driving device according to the present invention is exemplified and illustrated below for better illustration, rather than for limiting the present invention. However, it should be noted that those of ordinary skill in the art may modify the following embodiments, which shall be construed to be within the scope of the present invention.

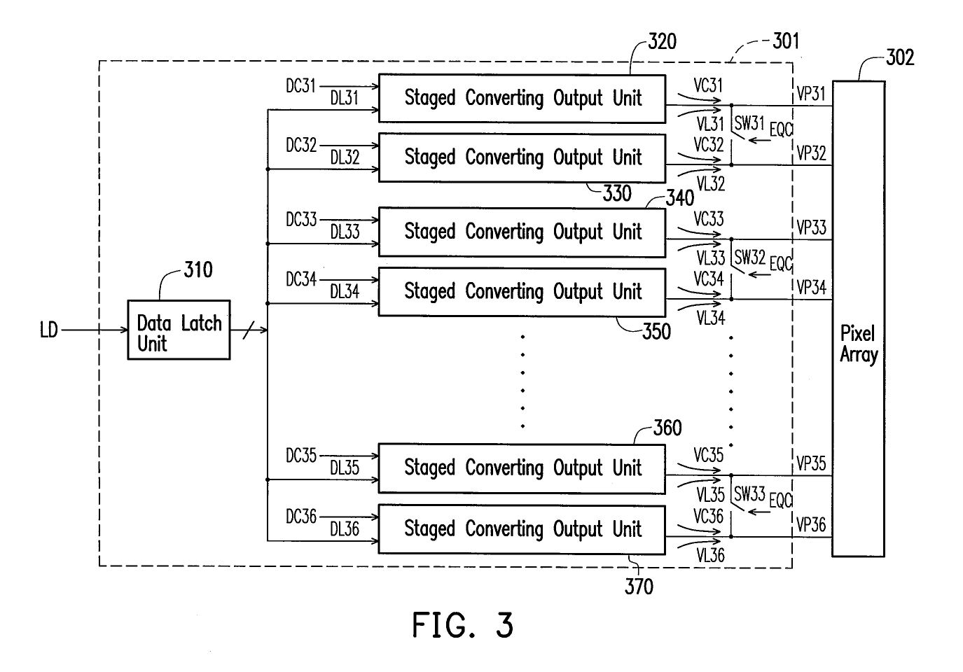

FIG. 3 is a schematic structural diagram illustrating a source driving device according to a preferred embodiment of the present invention. Referring to FIG. 3, a source driving device 301 includes a data latch unit 310, and staged converting output units 320-370. The staged converting output units 320-370 are coupled between the data latch unit 310 and the pixel array 302.

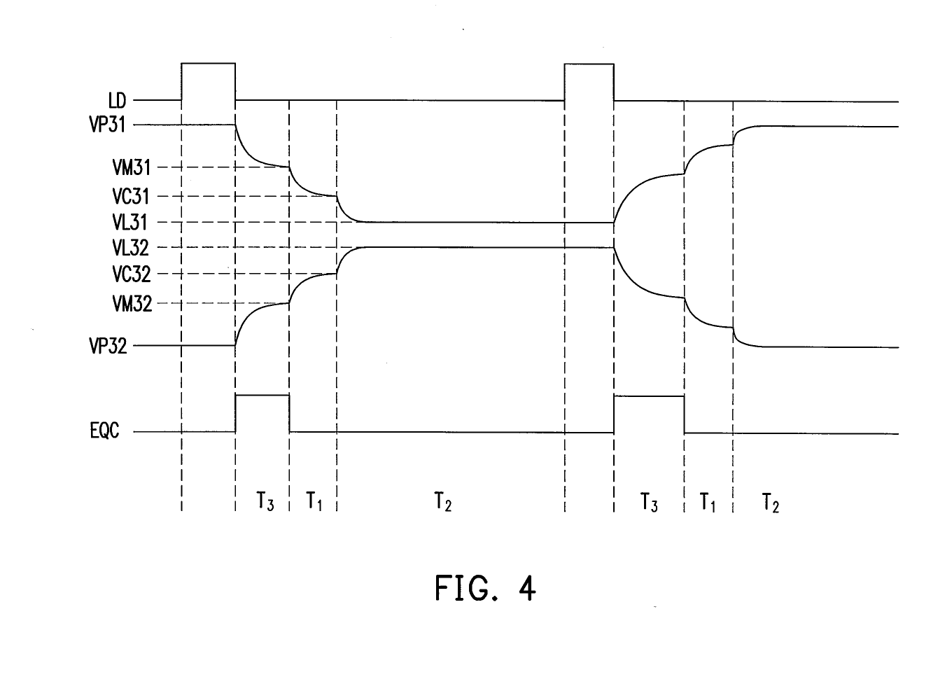

FIG. 4 is a time sequence diagram of the source driving device according to the preferred embodiment of the present invention. Referring to FIGS. 3 and 4, during the process of generating pixel voltages VP31-VP36 for driving the pixel array 302, the data latch unit 310 outputs digital latch data DL31-DL36 according to the latch result. The staged converting output units 320-370 generate precharging voltages VC31-VC36 during a first period by converting the digital precharging data DC31-DC36, and generate driving voltages VL31-VL36 during a second period by converting the digital latch data DL31-DL36. As such, the staged converting output units 320-370 charge/discharge the pixel array 302 stage by stage with the precharging voltages VC31-VC36 and the driving voltages VL31-VL36, wherein the digital latch data has a resolution of (M+L) bits, and the digital precharging data has a resolution of M bits, wherein M and L are integers greater than 0.

For example, in the first period T1, the staged converting output unit 320 generates a precharging voltage VC31 by converting the digital precharging data DC31. Correspondingly, the voltage level of the pixel voltage VP31 in the first period changes to the voltage level of the precharging voltage VC31. In the second period T2, the staged converting output unit 320 generates a driving voltage VL31, by converting the digital latch data DL3. Similarly, during the second period T2, the voltage level of the pixel voltage VP31 changes to the voltage level of the driving voltage VL31. In other words the staged converting output unit 320 charges/discharges the pixel array in stages by employing the precharging voltage VC31 and the driving voltage VL31 to change voltage level of the pixel voltage VP31.

Likewise, when the staged converting output unit 330 is in the first period T1, it generates the precharging voltage VC32 by converting the digital precharging data DC32. When the staged converting output unit 330 is in the second period T2, it generates the driving voltage VL32 by converting the digital latch data DL32. In such a way, the level of the pixel voltage VP32 changes as the levels of the precharging voltage VC32 and the driving voltage VL32 change. Thus, the staged converting output unit 330 charges/discharges the pixel array 302 in stages. The rest staged converting output units 340-370 may be deduced by analogy.

It is to be noted that the (M+L) bits of the digital latch data DL31-DL36 is “b[1] to b[M+L]”, wherein b[1] is the most significant bit of the digital latch data DL31-DL36, and b[M+L] is the least significant bit of the digital latch data DL31-DL36, then the M bits of digital precharging data DC31-DC36 is “b[1] to b[M]”.

Referring FIG. 3, the foregoing source driving device 301 further includes switches, e.g., SW31-SW33 as shown, wherein the i^{th} switch has a first terminal coupled to an output terminal of the (2*i−1)^{th} staged converting output unit, and a second terminal coupled to an output terminal of the (2*i)^{th} staged converting output unit, wherein i is an integer greater than 0.

For example, the staged converting output units 320-350 are respectively the 1^{st} to the 4^{th} converting output units of the source driving device 301, and the switches SW31 and SW32 are respectively the first and the second switches of the source driving device 301. Therefore, a first terminal of the switch SW31 is coupled to an output terminal of the staged converting output unit 320, and a second terminal of the switch SW31 is coupled to an output terminal of the staged converting output unit 330. Similarly, a first terminal of the switch SW32 is coupled to an output terminal of the staged converting output unit 340, and a second terminal of the switch SW32 is coupled to an output terminal of the staged converting output unit 350. Likewise, the switch SW33 is coupled to the converting output units 360-370.

Referring to FIGS. 3 and 4, the switches SW31˜SW33 turn on during a third period T3, in accordance with a control signal EQC, by which charges of two adjacent channels are redistributed. In such a way, levels of pixel voltages of two adjacent channels respectively either raises or declines to a level of a median voltage. For example, as the switch SW31 turns on during the third period T3 according to the control signal EQC, levels of the pixel voltages VP31 and VP32 that are of two adjacent channels respectively change accordingly. The pixel voltage VP31 declines to a level of a median voltage VM31, and the pixel voltage VP32 declines to a median voltage VM32.

It is to be noted that before the first period T1 and the third period T3, the data latch unit 310 generates digital latch data DL31-DL36 in accordance with the data latch signal LD.

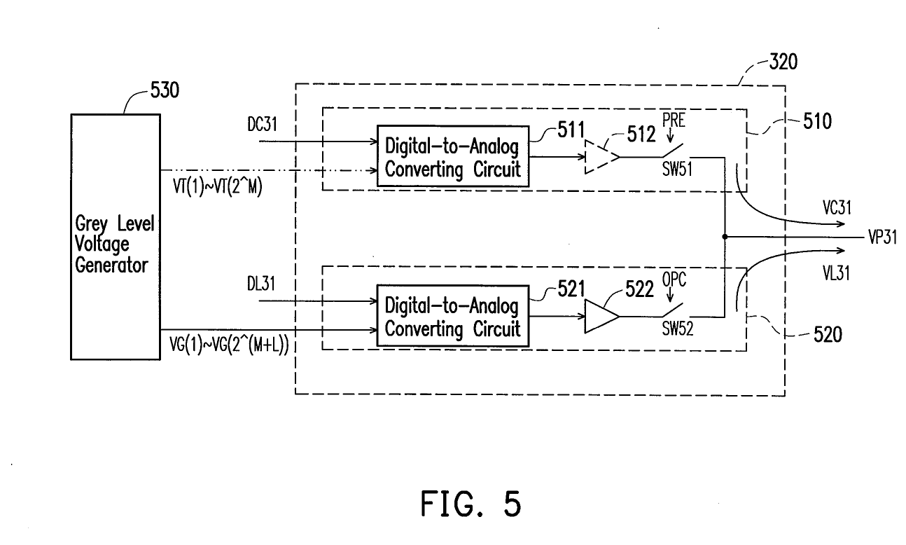

FIG. 5 is a structural diagram of a staged converting output unit according to an embodiment of the present invention. For illustrating the present invention, FIG. 5 also describes the grey level generator 530. Referring to FIG. 5, the staged converting output unit 320 includes a coarse adjustment digital-to-analog converter 510 and a fine adjustment digital-to-analog converter 520. The coarse adjustment digital-to-analog converter 510 is adapted for generating the precharging voltage VC31 according to a digital precharging data DC31 in the first period T1, while the fine adjustment digital-to-analog converter 520 is adapted for generating a driving voltage VL31 according to the digital latch data DL31 in the second period T2.

The coarse adjustment digital-to-analog converter 510 includes a digital-to-analog converting circuit 511, a buffer circuit 512 and a switch SW51. The buffer circuit 512 is coupled to the digital-to-analog converting circuit 511, and the switch SW51 is coupled between the buffer circuit 512 and the pixel array 302.

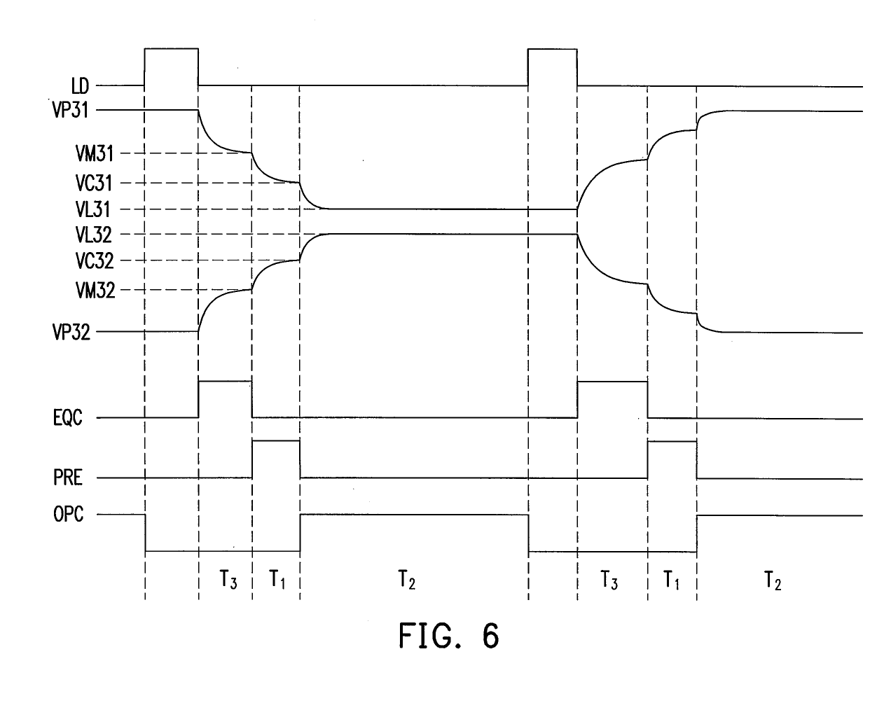

FIG. 6 is a time sequence diagram of the staged converting output unit according to the preferred embodiment of the present invention. Referring to FIGS. 5 and 6, in operation of the coarse digital-to-analog converter 510, the digital-to-analog converting circuit 511 selects one from 2̂M pre-adjusted voltages VT(1) to VT(2̂M) to output according to the digital precharging data DC31. The buffer circuit 512 is used to improve the driving capability of the output signals of the digital-to-analog converting circuit 511 so as to generate the precharging voltage VC31. The first switch SW51 is turned on in accordance with a control signal PRE during the first period T1, and the coarse digital-to-analog converter 510 is allowed to output the precharging voltage VC31.

It is to be noted that those skilled in the art may modify the present invention, for example, the switch SW51 may be integrated into the digital-to-analog converting circuit 511 or the buffer circuit 512. The digital-to-analog converting circuit 511 is also composed of a plurality of switches so that it is feasible to integrate the switch SW51 into the digital-to-analog converting circuit 511. As to the buffer circuit 512, the transistors included by the buffer circuit 512 may be combined with the switch SW51. For example, in order to combine the switch SW51 into the buffer circuit 512, a gate level of a P-type transistor included by the buffer circuit 512 can be raised to the operation voltage by the switch SW51, or a gate level of an N-type transistor included by the buffer circuit 512 can be lowered to a ground level by the switch SW51.

Furthermore, if the switches comprising the digital-to-analog converting circuit 511 are large enough, not only the switch SW51 can be integrated into the digital-to-analog converting circuit 511, but also the buffer circuit 512 can be removed. In other words, when integrating the switch SW51 into the digital-to-analog converting circuit 511, those who are skilled in the art can remove the buffer circuit 512 from the coarse adjustment digital-to-analog converter 510 according to the practical application, and the digital-to-analog converting circuit 511 electrically connected to the pixel array 302. As such, the digital-to-analog converting circuit 511 selects one from the pre-adjusted voltages, VT(1) to VT(2̂M), to output as the precharging voltage VC31, according to the digital precharging data DC31.

Further, as shown in FIG. 5, the fine adjustment digital-to-analog converter 520 includes a digital-to-analog converting circuit 521, an operation amplifying circuit 522, and a switch SW52. The operational amplifying circuit 522 is coupled to the digital-to-analog converting circuit 521. The switch SW52 is coupled between the operational amplifying circuit 522 and the pixel array 302.

Referring to FIGS. 5 and 6 together, the digital-to-analog converting circuit 521 is adapted for selecting one from 2̂(M+L) grey level voltages, VG(1) to VG(2̂(M+L)), to output, according to the digital latch data DL31. The operational amplifying circuit 522 is adapted to improve the driving capability of the output signals from the digital-to-analog converting circuit 521, so as to generate driving voltage VL31. During the second period T2, the switch SW52 can be turned on according to a control signal OPC, allowing the fine adjustment digital-to-analog converter 520 to output the driving voltage VL31.

It should be noted that, the grey level voltage generator 530 is coupled to the staged converting output units 320-370, and generates grey level voltages VG(1) to VG(2̂(M+L)) thereby. Those of ordinary skill in the art may set the grey level voltage generator 530 within the source driving device 301, or externally coupled to the source driving device 301 according to practical requirement. The pre-charged voltages VT(1) to VT(2̂M) can be provided by external elements of the source driving device 301, or by selecting 2̂M from the grey level voltages VG(1) to VG(2̂(M+L)) generated by the grey level voltage generator 530.

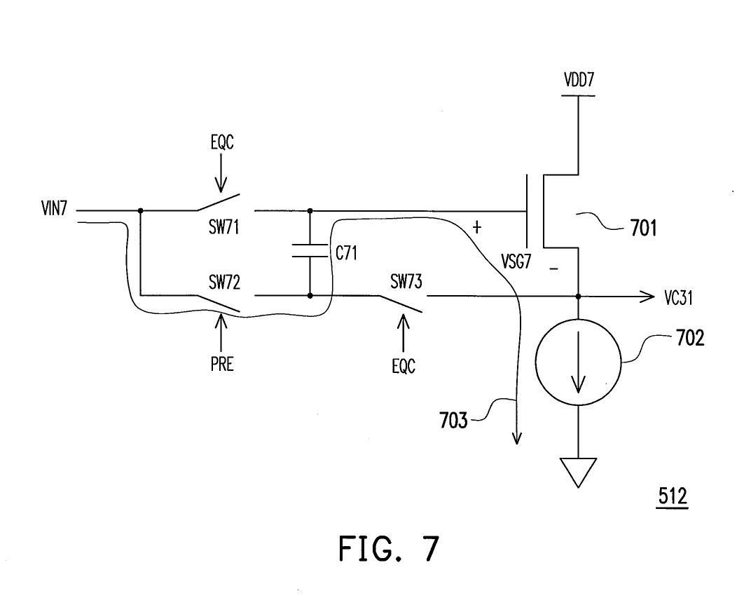

FIG. 7 is a diagram of a buffer circuit according to an embodiment of the present invention. Referring to FIG. 7, the buffer circuit 512 includes switches SW71-SW73, a capacitor C71, an N-type transistor 701, and a current source 702. The switches SW71 and SW72 have their first terminals coupled to the digital-to-analog converting circuit 511. A first terminal of the capacitor C71 is coupled to a second terminal of the switch SW71, and a second terminal of the capacitor C71 is coupled to a second terminal of the switch SW72. A first terminal of the switch SW73 is coupled to a second terminal of the switch SW72. The N-type transistor 701 has a drain coupled to an operation voltage VDD7, a gate coupled to the second terminal of the switch SW71, and a source coupled to the second terminal of the switch SW73. The current source 702 has a first terminal coupled to the source of the N-type transistor 701, and a second terminal coupled to ground.

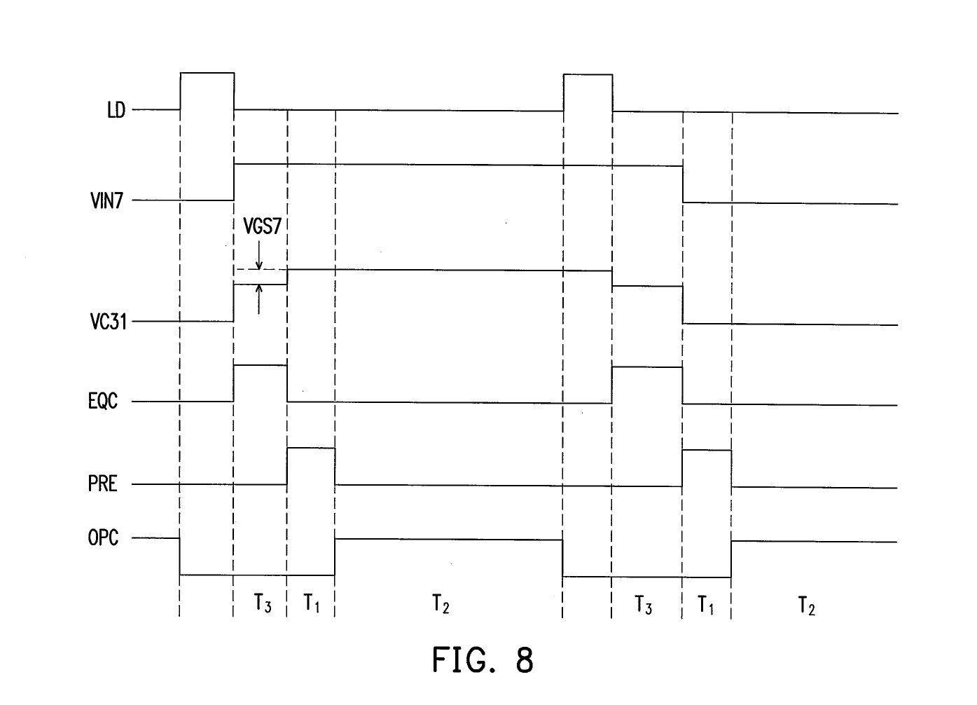

FIG. 8 is a time sequence diagram of the buffer circuit according to the embodiment of the present invention, wherein the output signal of the digital-to-analog converting circuit 511 is labeled as VIN7. Referring to FIGS. 7 and 8, the buffer circuit 512 enhances the driving capability of the signal VIN7 to the precharging voltage VC31. During the third period T3, the switches SW71 and SW73 are turned on according to the control signal EQC. Therefore, the gate-source voltage VGS7 of the N-type transistor 701 is stored in the capacitor C71.

In the first period T1, the switch SW72 turns on according to the control signal PRE. As shown in FIG. 7, the current loop marked with the arrow 703, the gate-source voltage VGS7 stored in the capacitor C71 in the first period T1 compensates the gate-source voltage VGS7 of the N-type transistor 701 in the current loop. Therefore, a difference between voltage levels of the precharging voltage VC31 respectively in the third period T3 and in the first period T1 is a gate-source voltage VGS7. In other words, in employing the control signals EQC and PRE to control the switches SW71-SW73, the level of the signal VIN7 and the level of the precharging voltage VC31 won't be differed as much as a gate-source voltage VGS7.

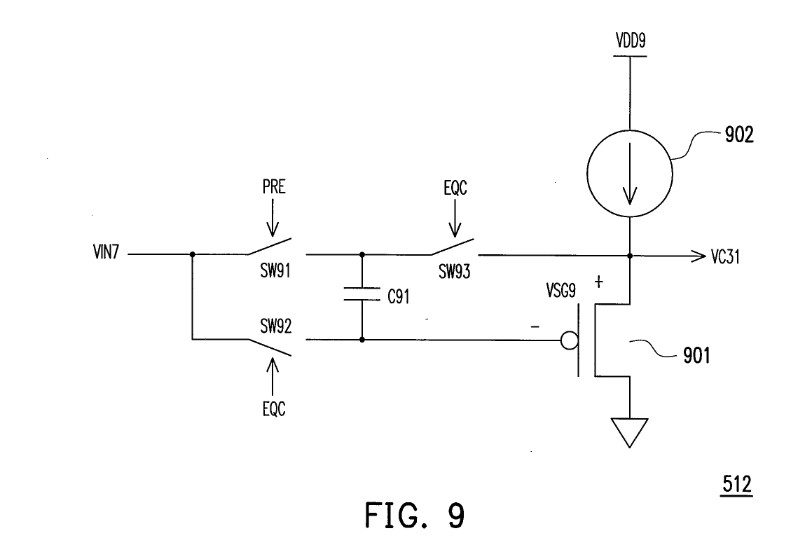

FIG. 9 is a diagram of another buffer circuit according to an embodiment of the present invention. Referring to FIG. 9, the buffer circuit 512 includes switches SW91-SW93, a capacitor C91, a P-type transistor 901, and a current source 902. The switches SW91 and SW92 have their first terminals coupled to the digital-to-analog converting circuit 511. A first terminal of the capacitor C91 is coupled to a second terminal of the switch SW91, and a second terminal of the capacitor C91 is coupled to a second terminal of the switch SW92. A first terminal of the switch SW93 is coupled to a second terminal of the switch SW91. The P-type transistor 901 has a drain coupled to ground, a gate coupled to the second terminal of the switch SW92, and a source coupled to the second terminal of the switch SW93. The current source 902 has a first terminal coupled to an operation voltage VDD9, and a second terminal coupled to the source of the P-type transistor 901.

The embodiment of FIG. 9 is similar with that of FIG. 7 in principle. First, in the third period T3, the switches SW92 and SW93 turn on according to the control signal EQC. Therefore, the capacitor C91 stores a source-gate voltage VSG9. In the first period T1, the switch SW91 turns on according to the control signal PRE, in that the level of the signal VIN7 won't differ from the level of the precharging voltage VC31 as much as a source-gate voltage VSG9.

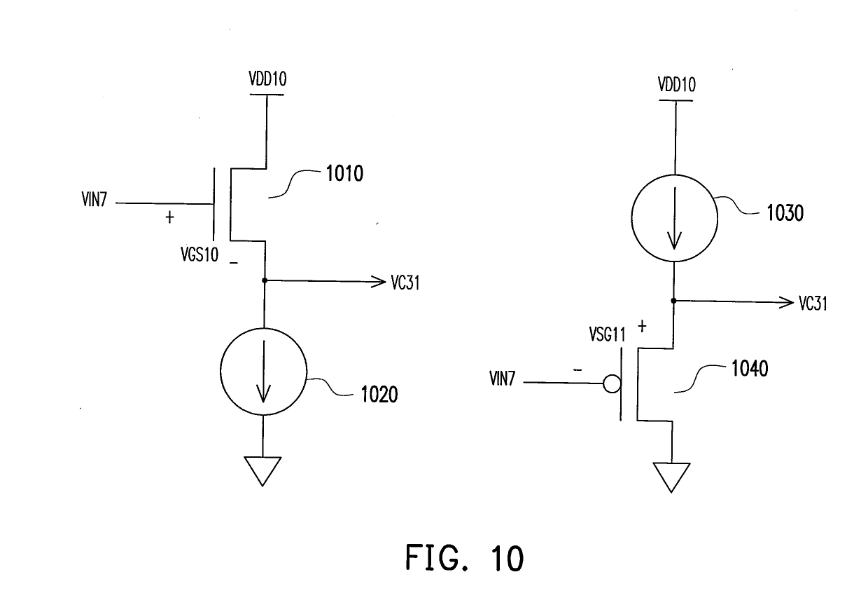

However, it is to be noted that the buffer circuit 512 of FIG. 5 can be composed of a source follower. For example, as shown in FIG. 10, it is a structural diagram of a source follower according to an embodiment of the present invention. The N-type transistor 1010 has a drain coupled to an operation voltage VDD10. The current source 1020 has a first terminal coupled to the source of the N-type transistor, and a second terminal coupled to ground. The P-type transistor 1040 has a drain coupled to ground. The current source 1030 has a first terminal coupled to the operation voltage VDD10, and a second terminal coupled to the source of the P-type transistor 1040.

Referring to FIG. 10, source followers either composed of the N-type transistor 1010 and the current source 1020, or composed of the current source 1030 and the P-type transistor 1040, can constitute the buffer circuit 512. However, it is to be noted that those buffer circuits 512 constituted by the source followers, may cause level difference between the signal VIN7 and the precharging voltage VC31, as much as a source-gate voltage (VGS or VSG). For example, the signal VIN7 and the precharging voltage VC31 of a buffer circuit 512 constituted by an N-type transistor 1010 and a current source 1020, are differed in level from one another about a gate-source voltage VGS10. The signal VIN7 and the precharging voltages VC31 of a buffer circuit 512 constituted by a P-type transistor 1030 and a current source 1040, are differed in level from one another about a source-gate voltage VSG11.

Furthermore, the source driving device according to the present invention is adapted for pixel arrays of liquid crystal displays (LCDs). Such LCDs include TFT LCDs.

In summary, the present invention utilizes a precharging voltage generated by a coarse adjustment digital-to-analog converter, and a driving voltage generated by a fine adjustment digital-to-analog converter, to change levels of pixel voltage, by which the staged converting output unit can charge/discharge the pixel array in stages. As such, the present invention can reduce static power consumption of the operational amplifying circuit, and can charge/discharge rapidly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driving device, adapted for a pixel array of a liquid crystal display (LCD), comprising:
a data latch unit, for outputting a plurality of digital latch data according to a latch result, wherein the digital latch data has a resolution of (M+L) bits, and wherein M and L are integers greater than 0; and
a plurality of staged converting output units, coupled between the data latch unit and the pixel array, each of the staged converting output units being adapted for generating a precharging voltage in a first period by converting a digital precharging data and generating a driving voltage in a second period by converting a digital latch data, and charging/discharging the pixel array in stages with the precharging voltage and the driving voltage, wherein the digital precharging data has a resolution of M bits.

2. The source driving device according to claim 1, wherein the (M+L) bits of the digital latch data are b[1] to b[M+L], in which b[1] is a most significant bit of the digital latch data, and b[M+L] is a least significant bit of the digital latch data, wherein the M bits of the digital precharging data are from b[1] to b[M].

3. The source driving device according to claim 1 further comprise:
a plurality of switches, wherein an i^{th} switch has a first terminal coupled to an output terminal of a (2*i−1)^{th} staged converting output unit, and a second terminal coupled to an output terminal of the (2*i)^{th} staged converting output unit, where i is an integer greater than 0.

4. The source driving device according to claim 1, wherein the staged converting output unit comprises:
a coarse adjustment digital-to-analog converter, for generating the precharging voltage according to a digital precharging data in the first period; and
a fine adjustment digital-to-analog converter, for generating a driving voltage according to the digital latch data in the second period.

5. The source driving device according to claim 4, wherein the coarse adjustment digital-to-analog converter comprises:
a first digital-to-analog converting circuit, for selecting one from 2̂M pre-adjusted voltages according to the digital precharging data to output as the precharging voltage, wherein the first digital-to-analog converting circuit outputs the precharging voltage during the first period.

6. The source driving device according to claim 4, wherein the coarse adjustment digital-to-analog converter comprises:
a second digital-to-analog converting circuit, for selecting one from 2̂M pre-adjusted voltages according to the digital precharging data; and
a first buffer circuit, coupled to the second digital-to-analog converting circuit, for improving the driving ability of output signals of the second digital-to-analog converting circuit, so as to generate the precharging voltage, wherein the second digital-to-analog converting circuit outputs the precharging voltage during the first period.

7. The source driving device according to claim 4, wherein the coarse adjustment digital-to-analog converter comprises:
a third digital-to-analog converting circuit, for selecting one from 2̂M pre-adjusted voltages according to the digital precharging data;
a second buffer circuit, coupled to the third digital-to-analog converting circuit for improving the driving ability of output signals of the third digital-to-analog converting circuit, and generate the precharging voltage; and
a first switch, coupled between the second buffer circuit and the pixel array, wherein the first switch turns on during the first period.

8. The source driving device according to claim 4, wherein the fine adjustment digital-to-analog converter comprises:
a fourth digital-to-analog converting circuit, for selecting one from 2̂(M+L) grey level voltages according to the digital latch data;
an operational amplifying circuit, coupled to the fourth digital-to-analog converting circuit, for improving the driving ability of output signals of the fourth digital-to-analog converting circuit, and generate the driving voltage; and
a second switch, coupled between the operational amplifying circuit and the pixel array, wherein the second switch turns on during the second period.

9. The source driving device according to claim 8, wherein the coarse adjustment digital-to-analog converter comprises:
a fifth digital-to-analog converting circuit, for selecting one from 2̂M pre-adjusted voltages according to the digital precharging data to output as the precharging voltage, wherein the fifth digital-to-analog converting circuit outputs the precharging voltage during the first period.

10. The source driving device according to claim 8, wherein the coarse adjustment digital-to-analog converter comprises:
a sixth digital-to-analog converting circuit, for selecting one from 2̂M pre-adjusted voltages according to the digital precharging data to output; and
a third buffer circuit, coupled to the sixth digital-to-analog converting circuit, for improving the driving ability of output signals of the sixth digital-to-analog converting circuit, and generate the precharging voltage, wherein the sixth digital-to-analog converting circuit outputs the precharging voltage during the first period.

11. The source driving device according to claim 10, further comprising a grey level voltage generator coupled to the staged converting output units for generating 2̂(M+L) grey level voltages, wherein 2̂M grey level voltages are selected therefrom as the pre-adjusted voltages.

12. The source driving device according to claim 8, wherein the coarse adjustment digital-to-analog converter comprises:
a seventh digital-to-analog converting circuit, for selecting one from 2̂M pre-adjusted voltages according to the digital precharging data to output;
a fourth buffer circuit, coupled to the seventh digital-to-analog converting circuit, for improving the driving ability of output signals of the seventh digital-to-analog converting circuit, and generate the precharging voltage; and
a third switch, coupled between the fourth buffer circuit and the pixel array, the third switch being turned on during the first period.

13. The source driving device according to claim 12 further comprise:
a grey level voltage generator, coupled to the staged converting output units for generating 2̂(M+L) grey level voltages, wherein 2̂M grey level voltages are selected therefrom as the pre-adjusted voltages.

14. The source driving device according to claim 12, wherein the second buffer circuit comprises:
a fourth switch, having a first terminal coupled to the seventh digital-to-analog converting circuit, the fourth switch being turned on during the third period;
a fifth switch, having a first terminal coupled to the seventh digital-to-analog converting circuit, the fifth switch being turned on during the first period;
a first capacitor, having a first terminal coupled to a second terminal of the fourth switch, and a second terminal coupled to a second terminal of the fifth switch;
a sixth switch, having a first terminal coupled to a second terminal of the fifth switch, the sixth switch being turned on during the third period;
an N-type transistor, having a drain coupled to an operation voltage, a gate coupled to the second terminal of the fourth switch, and a source coupled to a second terminal of the sixth switch; and
a first current source, having a first terminal coupled to the source of the N-type transistor, and a second terminal coupled to ground.

15. The source driving device according to claim 12, wherein the second buffer circuit comprises:
a seventh switch, having a first terminal coupled to the seventh digital-to-analog converting circuit, the seventh switch being turned on during the third period;
an eighth switch, having a first terminal coupled to the seventh digital-to-analog converting circuit, the eighth switch being turned on during the first period;
a second capacitor, having a first terminal coupled to a second terminal of the seventh switch, and a second terminal coupled to a second terminal of the eighth switch;
a ninth switch, having a first terminal coupled to the second terminal of the seventh switch, the ninth switch being turned on during the third period;
a P-type transistor, having a drain coupled to ground, a gate coupled to the second terminal of the eighth switch, and a source coupled to a second terminal of the ninth switch; and
a second current source, having a first terminal coupled to an operation voltage, and a second terminal coupled to the source of the P-type transistor.

16. The source driving device according to claim 1, wherein the LCD is a thin film transistor (TFT) LCD.
